(19) United States
(12) Patent Application Publication
(10) Pub. No.: US 2016/0217214 A1
(43) Pub. Date: Jul. 28, 2016

(54) System and Method for Real Estate Asset Management

(71) Applicant: HOMETELOS, L.P., Dallas, TX (US)

(72) Inventor: Gabriel P. Goncalves, Dallas, TX (US)

(21) Appl. No.: 15/087,537

(22) Filed: Mar. 31, 2016

Related U.S. Application Data
(63) Continuation of application No. 10/738,109, filed on Dec. 17, 2003.
(60) Provisional application No. 60/434,146, filed on Dec. 17, 2002.

(51) Int. Cl. G06F 17/30; G06F 3/0482

(52) U.S. Cl. CPC G06F 17/30867; G06F 17/30241; G06F 17/3087; G06F 3/0482; G06Q 50/16

(57) ABSTRACT

A system and method for management of real estate assets via a network of the various participants in real estate management is disclosed. Users include asset managers and related service providers. All users can track and share information on assets, use standard forms for various activities and transactions related to such assets, electronically communicate and coordinate activities and transactions, and collect and analyze information regarding each activity or transaction associated with such assets.

### CROSS-REFERENCE TO RELATED APPLICATIONS

This application is related to co-pending provisional application Ser. No. 60/434,146, filed Dec. 17, 2002, which is incorporated herein by reference for any and all purposes.

### TECHNICAL FIELD

This invention relates to real estate asset management, and more particularly to a system and method for the coordinated management of real estate assets, such as residential property.

### BACKGROUND

End-to-end real estate asset management involves a community of different entities providing a number of different, but related, services. Just a few examples of the various entities involved in a typical transaction involving real estate include lenders, subcontractors and brokers.

Historically, each of the individual players in this process has provided its part of the overall process in a virtual vacuum, manually completing one or more transactions without facilitated communication with the other players in the overall process, or the coordinated collection and sharing of information about the asset(s) involved. As a result, the overall process, as well as the individual players, suffer from a number of inefficiencies.

To the extent the various players in real estate management transactions maintain any internal systems or methods for providing their individual component of the overall process, such internal systems (to the extent they are utilized) suffer from a lack of communication with, and information on, the other players and/or transactions involved with a particular real estate asset. At best, such legacy systems might facilitate one aspect of the role of a single participant in the larger process of the transaction(s) involved.

Attempts to automate real estate transactions exist. One example is described in U.S. Pat. No. 6,594,633, entitled Real Estate Computer Network, to Broerman (the Broerman Patent). The Broerman Patent purports to provide the seller of real estate properties a do-it-yourself option to avoid using a real estate agent for a real estate transaction. Importantly, the network of the Broerman Patent is directed to the sellers and buyers of real estate, and does not provide a comprehensive system with customized entry points for the various participants related to a real estate transaction. In effect, the network of the Broerman Patent attempts to provide an electronic “agent” for use by the sellers and buyers of real property, and does not address providing an end-to-end system for real estate asset management.

A system and method capable of tracking and managing real estate assets using coordinated communication and information gathering and sharing between all participants in a real estate transaction and throughout the entire process would provide a number of procedural, time and cost advantages to the overall process, as well as the constituent players in such process.

### SUMMARY

The present invention comprises a system and method of end-to-end real estate asset management. In a preferred embodiment, the present invention is a software-based application accessible via the Internet. The application provides comprehensive real estate asset tracking and communications between the various parties involved in real estate management, such as a transaction involving the transfer of a real estate asset from one party to a new party, as well as the various other activities and interactions that occur between the various participants related to the transaction.

The application is scalable, with customized entry points for the various parties associated with real estate management. Utilizing the present invention, the various parties (e.g., real estate management companies, lenders, sub-contractors, attorneys and brokers) associated with the acquisition and disposition of real estate assets can interact, share information and otherwise conduct and facilitate transactions associated with such asset on a real-time basis.

A preferred embodiment of the present invention application comprises one or more “centers” related to the various players in the acquisition and disposition of real estate assets. For example, one such center is the “Lender Center”, where various lenders interface with the present invention system, and through which lenders interact with the other players in real estate management of the lender-owned or managed assets. Similarly, there is a “Service Center,” through which numerous types of service providers relating to real estate assets (e.g., subcontractors) interface with the present invention system and interact with the other players in transactions related to real estate management. Other exemplary “centers” include: a Broker Center (interface for brokers to access the system, list properties, and interface with others utilizing the system); and an Asset Center (interface for property owners to view status of disposition of asset utilizing the present invention).

The various “centers” represent customized entry points to the application and system of the present invention. Being organized around such centers, the overall system remains flexible and can be modified, if needed, to add, modify or subtract entry points for those involved in transactions that affect real estate assets and transactions involving same. It is noted that one or more entities may access the system of the present invention via one or more of the centers, depending upon the role(s) that entity is playing with respect to a particular real estate asset and/or transaction. So, for example, a bank may access and utilize the system via the Lender Center (since it may lend money for a transaction involving the transfer of an asset) as well as the Asset Center (since it may hold title to the real estate asset at issue), depending upon its role with respect to a particular real estate asset. Indeed, the same entity may even play more than one role with respect to a given property.

Not only are the varying centers customized to be access points for various players, they also serve to limit access of a user and use of information, features, etc., of the system by that user to only those appropriate for the role the user is playing in the overall process. For example, an entity acting as a lender does not need access to the same features, raw information, etc., as a broker. Although some of the information overlaps and one advantage of the system is sharing information to facilitate real estate transactions of various kinds, there are significant benefits to limiting and customizing the experience of individual players utilizing the system.

The present invention is preferably a web-based application available online via access of a site on the world wide web of the Internet. This type of embodiment provides entities of all types, sizes and relative resources ample access to the invention in one of a number of ways to access the Internet (e.g., computers, PDAs, wireless devices, etc.). By utilizing the present invention, those various players in real estate asset management may communicate, track and share information on assets, significantly reducing the time and expense associated with conducting the same transactions without the benefit of the present invention system and method.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating an embodiment of the system and method for real estate asset management of the present invention;

FIG. 2 is a block diagram illustrating another embodiment of the present invention system;

FIGS. 3A-3E are a series of “screenshots” of an embodiment of the system for real estate asset management of the present invention; and

FIG. 4 is a flow diagram outlining the steps of an embodiment of the method of the present invention.

Like reference symbols in the various drawings indicate like elements.

### DETAILED DESCRIPTION

According to the principles of the present invention, one embodiment includes a web-based application through which various individuals associated with the various transactions comprising end-to-end real estate asset management may access and utilize various tools, communicate with other players in real estate asset management, and track and share information about such assets. For purposes of this application, the terms “real estate property” and “real estate assets”, or just “property(ies)” and “asset(s),” will be used interchangeably.

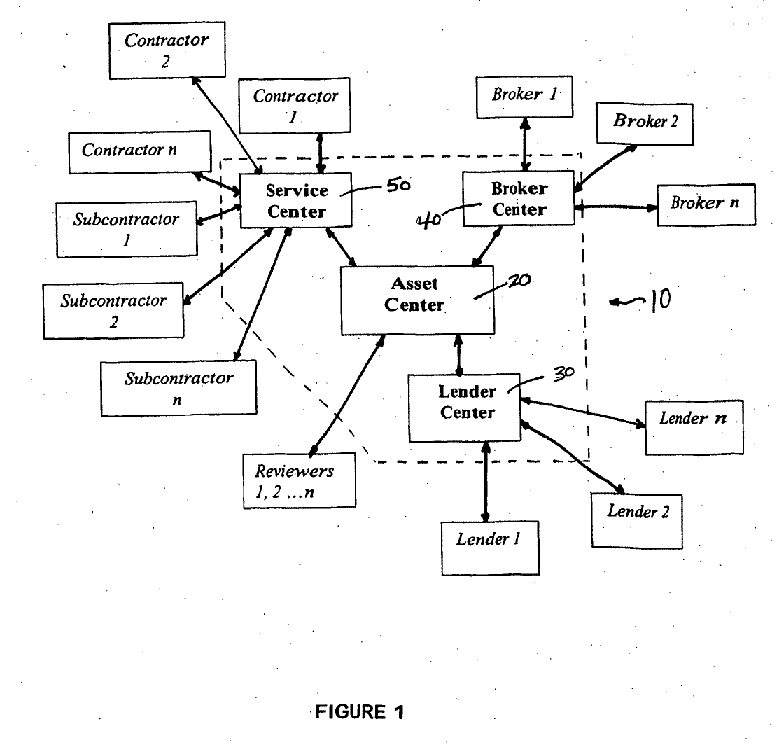

In FIG. 1 there is shown an embodiment of the system of the present invention. The system 10 is comprised of a number of “centers.” For purposes of illustration only, the system 10 in FIG. 1 includes an Asset Center 20, a Lender Center 30, a Broker Center 40 and a Service Center 50. Each center represents a customized entry point into the system 10. Utilizing one or more remote computers or other access devices (e.g., personal digital assistants, telephones), individuals associated with the various roles comprising real estate asset management access the system 10 via the appropriate center(s). For example, brokers (Broker 1, 2 . . . n) access the system 10 via the Broker Center 40. Likewise, any number of lenders (Lender 1, 2 . . . n) access the system via the Lender Center 30, service providers (Contractor 1, 2 . . . n, and Subcontractor 1, 2 . . . n), such as maintenance providers, carpenters, plumbers, electricians, and the like, access the system via the Service Center 50, and owners of assets managed and tracked by the system (e.g., banks, title companies, governmental agencies) interact with the system 10 via the Asset Center 20. It is noted that although centers for lenders, brokers, service providers and asset holders are described, the system 10 is capable of accommodating any participant in the real estate management area. If desired, other centers are available to provide customized access to the system 10 for other such participants, such as attorneys, listing agents, marketing companies, governmental agencies, etc.

The various “centers” of the system 10 can be thought of as customized interfaces between the various participants in real estate management and the system 10. In a preferred embodiment, these centers are customized web-based sites via which the various participants access and interact with the system 10. Such sites can be accessed via any appropriate network, such as the Internet (e.g., the world wide web) or any private communications network. These centers are customized in that they limit access of the various participants to just those portions and other participants in the system 10 with which that particular participant has reason to interface or access. As an example, individuals working for a real estate asset management company may access various tools for tracking and managing real estate properties via the Asset Center 20. The real estate asset management company may manage real estate assets that it owns or that it is contracted to manage by third parties. Users within the real estate asset management company may use the features of the present invention to track various aspects of the real estate assets, for example, but would have no reason to access those portions of the system 10 used by the various service providers (e.g., subcontractors), for example.

It is noted that although the use of remote computers by various participants is described above, the various participant can access the system via the customized centers (e.g., Asset Center 20) employing any appropriate device. Examples of such devices include, without limitation, desktop computers, servers, workstations, handheld devices, personal digital assistants, telephones and any other suitable electronic communication device. Moreover, the foregoing examples can be either wired or wireless devices.

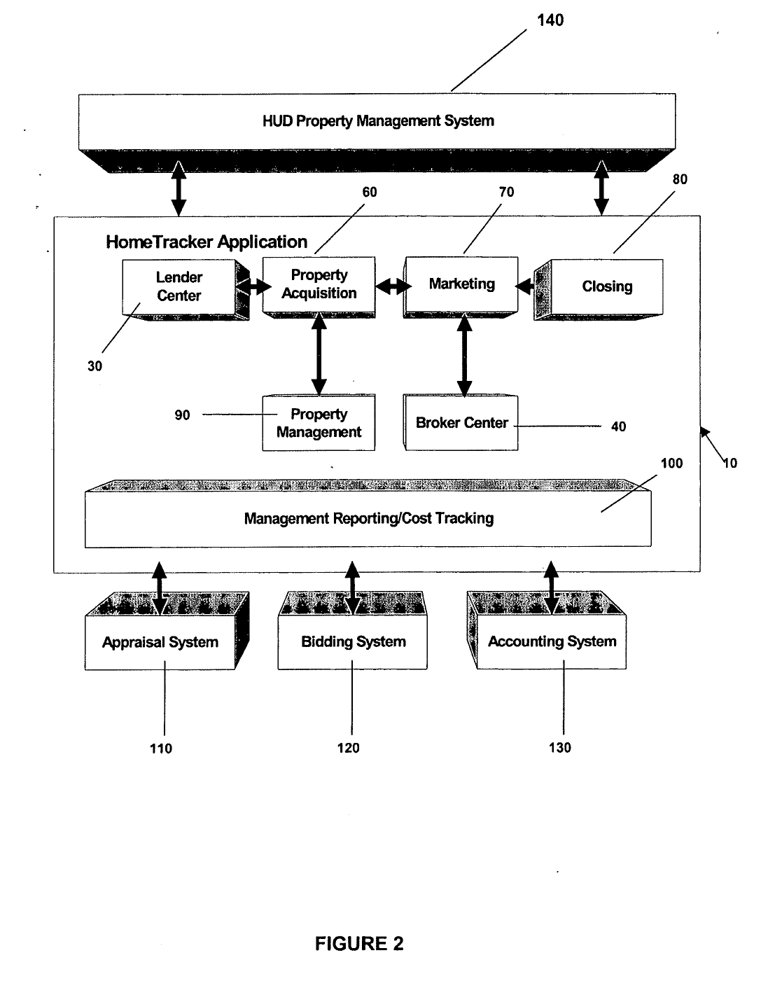

Another embodiment of the present invention system and apparatus is illustrated in FIG. 2. The system 10 is shown in relation to the various third party systems and entities with which it may interface and communicate. Within this embodiment of the system 10 are representative centers, the Lender Center 30 and the Broker Center 40, a property acquisition module 60, a marketing module 70, a closing module 80, a property management module 90, and a management report/cost-tracking module 100. Appropriate users, namely lenders and brokers, interface with the system 10 via the Lender Center 30 and the Broker Center 40, respectively. Sitting outside the system 10 in this embodiment are an appraisal system 110, a bidding system 120, an accounting system 130 and the third party property management system 140.

A feature of the system 10 is that each participant can track relevant activities, milestones, etc., with respect to the various roles played by those participants. For example, an asset holder may track and manage the acquisition of real estate assets it holds. The system 10 provides a real time electronic record of the transaction history associated with each asset and its interaction with the various modules within the system 10. Reports based upon such electronic record can be accessed, printed and downloaded for use outside the system (e.g., in an Excel™ spreadsheet). The user may also track documents related to the asset and manage and track inspections required on the property, for example. The system 10 also automatically generates work orders and letters of notification related to the asset, as well as provide the user a breakdown on the expenses incurred in connection with the asset.

Other participants are able to track other, relevant activities with respect to their role(s) with real estate asset management. For example, an appraiser may submit an electronic version of an appraisal to the asset holder utilizing the present invention system. The system 10 will then match the appraisal to the corresponding asset and update the corresponding electronic record for that asset. Additionally, utilizing this feature, the asset holder may view and track which assets have been appraised and which still require appraisals to be conducted. Further, the system 10 of the present invention offers the asset holder access to third party appraisal databases via the appraisal module 110 to substantiate and compare the appraised values.

Yet another feature of the system 10 is that each participant center facilitates electronic communication between that participant group and any other relevant participant group, further streamlining the overall process of real estate management. For example, real estate management professionals have a regular need to interact with the various service providers within the system 10, for example, to bid repair and maintenance work that may be needed on the assets managed by the real estate management professional. Such communications, including the use of standard forms, contracts and other documents are facilitated by system 10 via the Asset Center 20 and the Service Center 50.

The marketing of real estate assets is a further feature of the present invention. All relevant information regarding a particular asset in the system 10 is available real time via the system 10 to determine appropriate disposition options for the assets. For example, utilizing the marketing module 70, a user may generate automated listings of the available real estate assets by category, location, etc. The user may also readily access a broker and agent database within the system to assign listings and communicate with the appropriate broker via the system 10.

Another feature of the system 10 tracks deposits paid by buyers to sellers for assets within the system 10 to demonstrate intention to complete the purchase, (i.e., “earnest money.”) Any extension fees paid by the buyer to extend the contract period on an asset may also be tracked through the system 10. Further, the user may access HUD1 data on an asset utilizing the system 10.

Using the report generation feature of the system 10 (the management reporting/cost-tracking module 100), a user may generate a wide variety of reports to track and manage real estate assets. For example, the user may generate work-flow reports that identify actions to be taken on an asset to facilitate its movement through the system 10 from acquisition to closing. The user may also generate management and oversight reports on each property, and properties together, to compare and contrast the management of such assets.

The standard reports available through the management reporting/cost-tracking module 100 of the system 10 may be broken down into two general categories: management; and worklists/tracking reports. The category of management reports may be further divided into three distinct categories: property management; oversight; accounting; and archive reports. Under property management, reports are available on the following property aspects: routine services; work orders; contractor inventory logs; cost tracking; routine inspection; repair inspections; utility disconnections; property inventory; termite treatment; listing condition reports (LCR) not reviewed; and LCR results. Under oversight reports, the user may generate reports on reconciliation of the user's system, listed and sold property performance and missing LCR. Finally, reports may be generated based on archived data such as a closed properties summary, file index, sales, selling agents and reconveyed properties.

Utilizing the worklists/tracking reports tool, the user may generate reports related to acquisition of a property, marketing of a property and closing. The user may generate reports on various aspects concerning the acquisition of properties including: approved appraisals; late appraisals; acquisition tracking; utility comparison; mortgagee neglect (i.e., actions a lender should have taken to preserve and protect the property in question prior to handing it over to a property management entity); termite review and initial inspections received. The user may also generate different reports related to the marketing of real estate assets, including: initial property listings; program listings; properties ready for disposition; reanalysis; contract review; and broker price opinion reports. The user may also generate reports related to closing including properties scheduled to close, closing status updates, properties with expired deeds, delinquent post packages, late notifications related to the closing and closed properties.

In another embodiment of the system and method of the present invention, the system includes a utility capable of providing current status updates regarding a real estate property. A broker user interfacing with the system 10 via the Broker Center 40 may update marketing details regarding a property, including adding notes on the property and/or adding one or more digital pictures of the property and/or other additional content (e.g., video clip) to the record of the property in the system. Further, the broker user may automate listings and broker price options and generate workflow and management reports through the system.

In another type of report, case listings are generated via user input of data related to real estate properties. The case listings provide a complete listing of active cases in the system.

Finally, again utilizing the management reporting/cost-tracking module 100 of the system 10, the user may track the costs associated with each real estate asset to determine and generate profit and loss statements for such asset. Such analysis may be conducted on a per property, or portfolio-wide, basis. The cost tracking aspect of the system 10 is capable of being integrated with standard accounting systems.

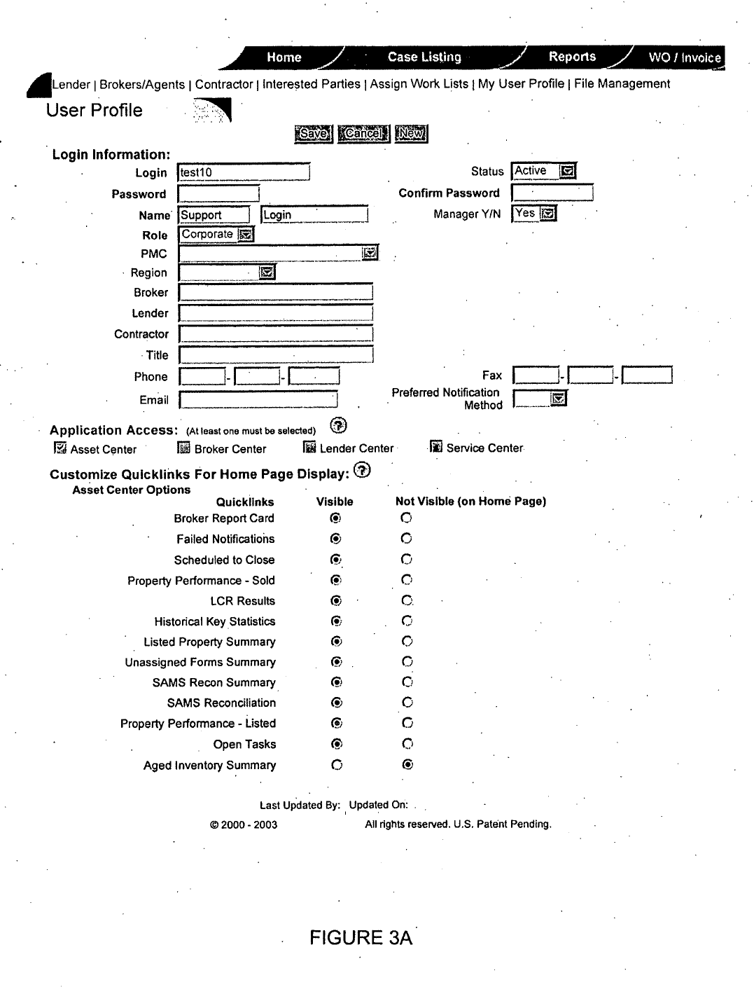

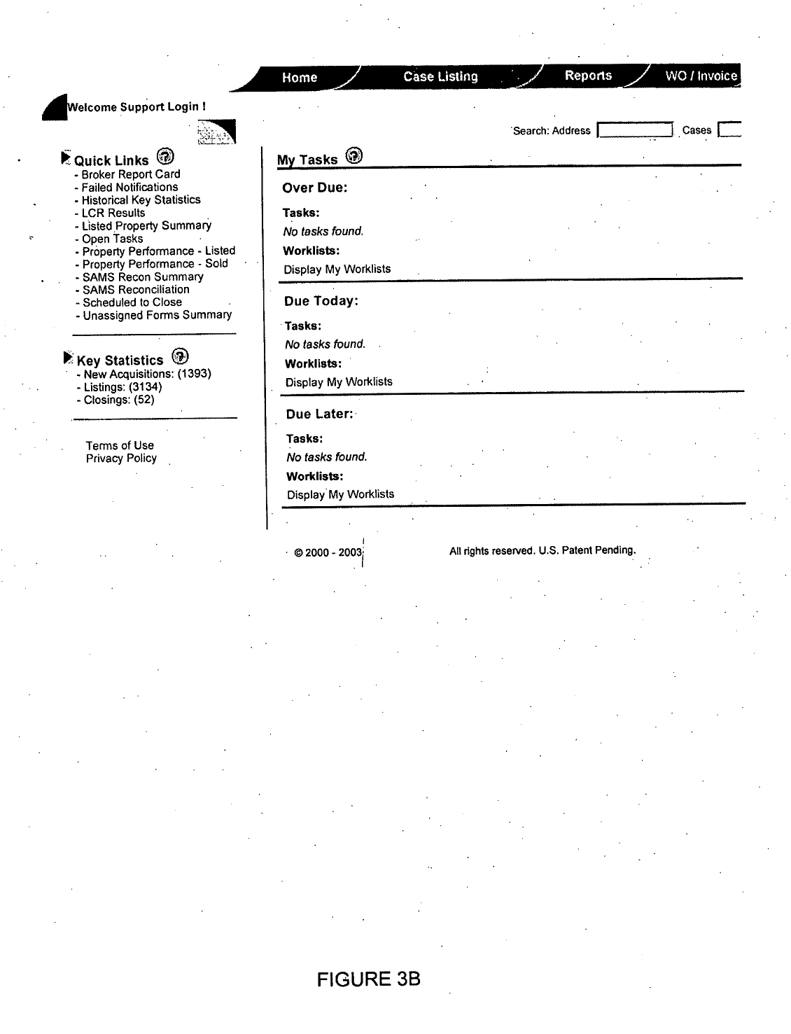

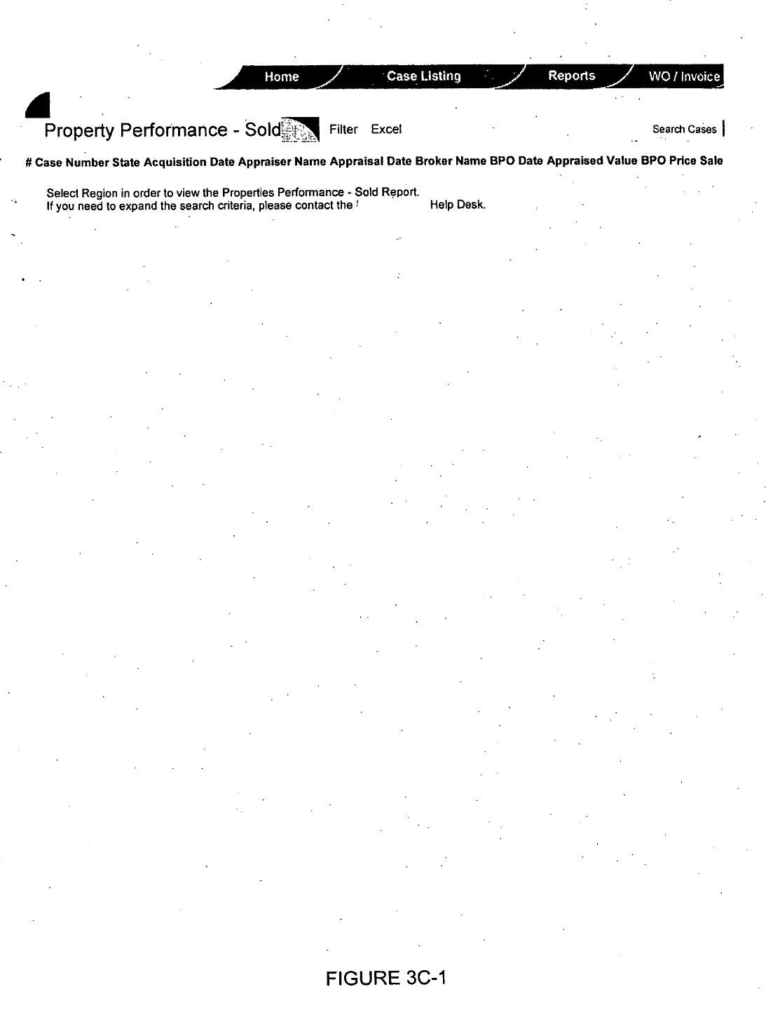

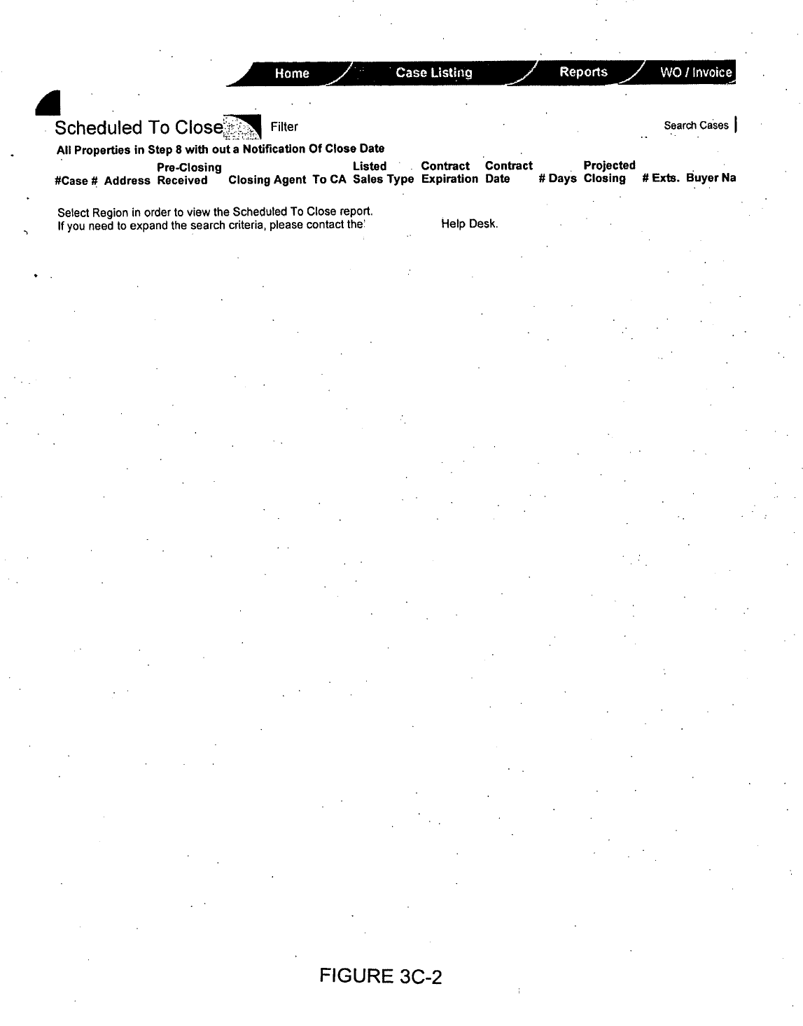

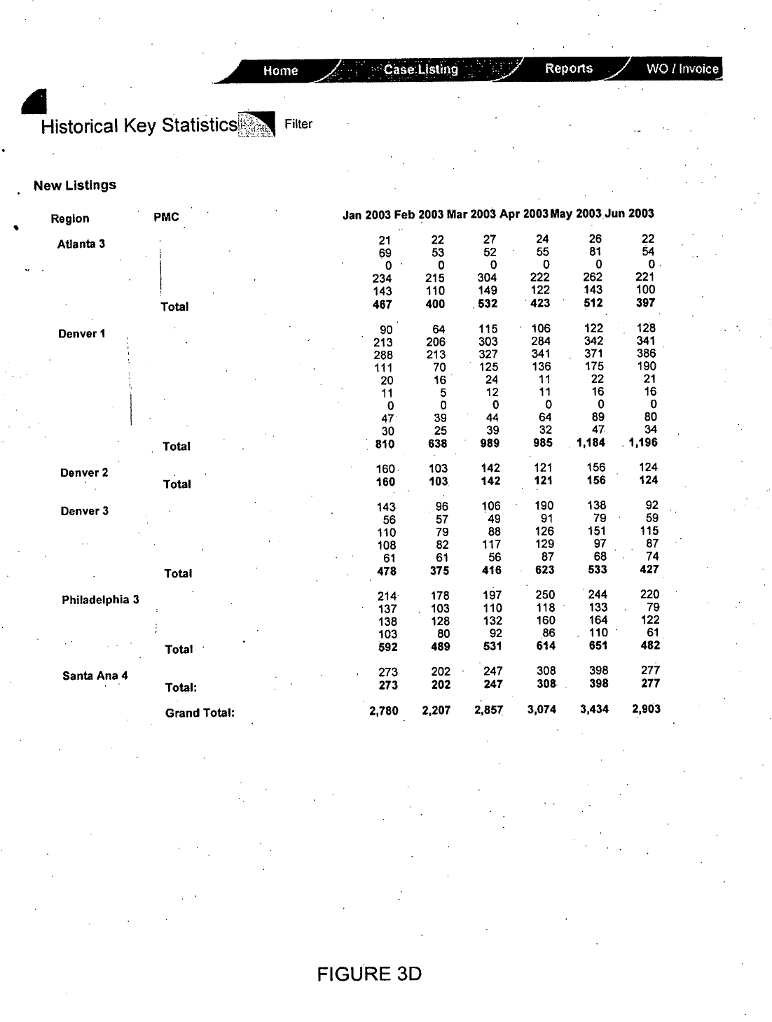

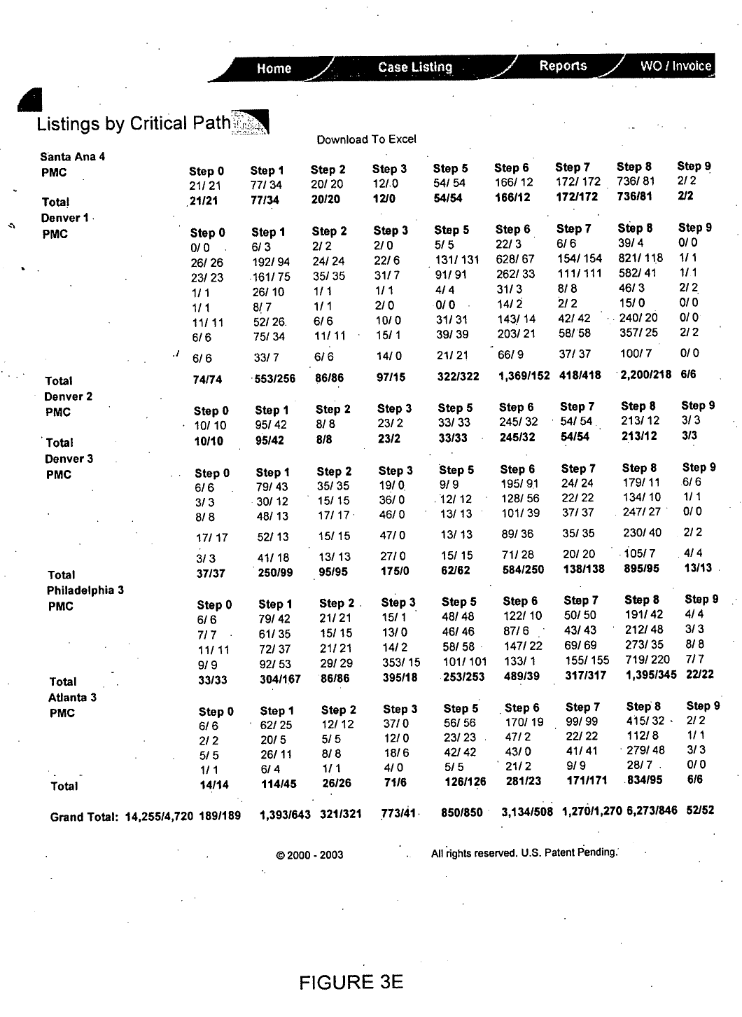

Turning to FIGS. 3A-3E, there are shown representative “screen shots” illustrating the various services and features of the system 10. In FIG. 3A, a User Profile screen is shown. Regardless of the role within real estate property management, the user can provide background and identifying information on itself, apply for access to the system 10 via the relevant access centers (e.g., Asset Center 20) and set defaults for its interface with the system 10.

FIG. 3B shows a screen shot of a primary user interface page that has been customized for a user. Utilizing information input by the user in the User Profile section (FIG. 3A), the user has customized its primary interface screen with system to include along the right-hand side of the page the Quick Links that the user most utilizes. Quick Links are shorthand links (e.g., hyperlinks) that take the user to specific modules or features of the system 10. This interface page also lists tasks for the user, items that are due that day and various worklists. Additionally, key statistics regarding the assets listed by that user are provided on the lower right-hand side of the page.

FIGS. 3C-1 and 3C-2 show screen shots of list of real estate assets that have been sold, and those that are scheduled to close, respectively. It is noted that for each such screen, the user can use a “filter” option to control the display of information. For example, in the Scheduled to Close screen, the user can filter the results display based upon a number of parameters, including case number, project closing dates, closing agent, etc. This allows the user to derive additional value from the raw data tracked, stored and accessible from the system 10.

FIG. 3D shows a screen shot (user identifying information has been redacted) of historical key statistics for a user. Here again, the user can use filter parameters to display the data in a number of ways that assist the user in deriving value from the raw data.

As shown in FIG. 3E, a user can view its listed assets according to the “critical path” of each asset managed by the system 10. This feature of the present invention system and method is significant since the management of real estate assets follows one of a limited number of “paths” as an asset moves from acquisition to disposition over some time period (or from any point A to any point B on that continuum). The term critical path is used to describe the path of “steps” the listed assets encounter within the system 10. For example, “Step 1” corresponds to the acquisition or assignment of a property to an asset manager by the property owner to begin the real estate asset management process , “Step 2” denotes valuation of the property, and “Step 5” corresponds to the disposition of the property. For each step listed along the top of the page, the numbers listed in each category are hyperlinks that allow the user to click on them to see the actual case listings represented by the totals listed in that box. As listed along the top of the page, the information on the page can easily be uploaded to an application outside the system 10, such as a spreadsheet (e.g., an Excel™ spreadsheet).

Importantly, the present invention system and method are designed to both accommodate these traditional paths of progress from acquisition to disposition for real estate assets, and to allow users to customize such paths, while ensuring that all necessary steps are accomplished for the asset(s) listed with the system 10. This feature provides great value to real estate management participants as it prompts users to be prepared for the next “step” of the path, and will even automatically generate materials (e.g., documents, work requests, work lists, etc.) the user will likely need/be required to submit associated with such step.

There are numerous other reports, work lists, and screens associated with various features of the system 10 to ensure that the appropriate steps are prepared for and accomplished for a list asset as it moves from acquisition to disposition. Additionally, the modular design of the system allows for the addition, removal and/or modification of any such feature or module of the system 10. As a result, if a new requirement for inspecting a property, for example, is created by a governing agency, the system 10 can be modified to add this new requirement as a necessary “step” for real estate assets subject to same.

Another feature of the system 10 is the ability of the system 10 to electronically monitor use of the system 10 by the various users and to charge, and optionally collect (e.g., via credit card processing) one or more fees for such use. There are a wide range of fees that can be charged by the system, including annual fees, per transaction fees, listing fees and the like. The users may pay any such fees via means for accepting and processing payment included with the system 10 or via invoice and payment outside the system 10.

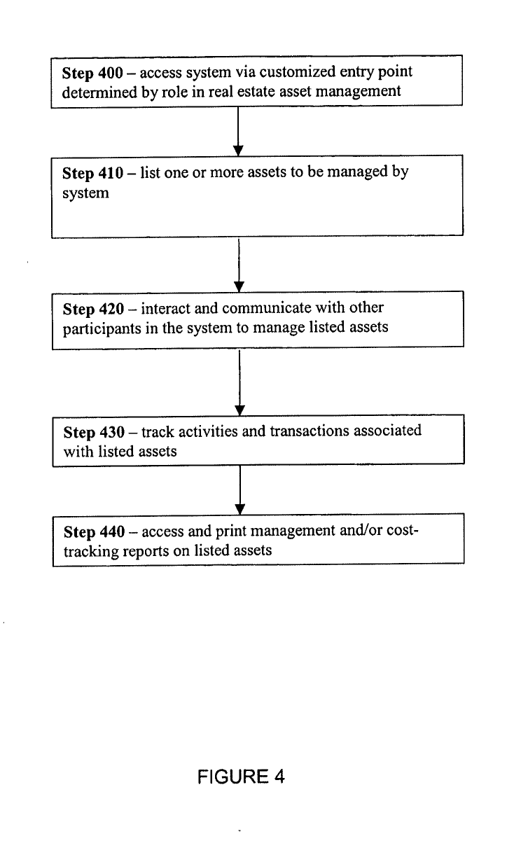

FIG. 4 illustrates the steps associated with an embodiment of the method of the present invention. In Step 400, a user accesses the system 10 via customized entry point determined by the role(s) of that user in real estate asset management. Representative users include lenders, asset managers, brokers, service providers (e.g., contractors) and the like. The use of the system 10 by a distribution of representative participants in real estate management creates a networked community linked by the system 10. The customized entry points are the various “Centers” described in greater detail above. The system 10 is designed to allow for the addition, removal and modification of the participation by various users.

In Step 410, the user lists one or more assets to be managed by the system 10. The representative user here is an asset manager. In contrast, a service provider, for example, would not list any assets for the system 10 to manage, but rather would provide information (e.g., expertise, skills, rates, standard agreement terms, etc.) about the service that the user provides related to real estate asset management so that other users could access and utilize these services in the course of management of the listed assets.

Step 420 occurs when the user interacts with the various other participants linked by the system 10 to manage listed assets. In effect, this step occurs in numerous sub-steps as the user, for example, has repairs completed on an asset via a service provider, requests an appraisal of the asset, lists the asset for sale, etc.

In Step 430, the user interacts with the system 10 to track activities and transactions associated with listed assets. This can be accomplished either on a per asset or complete portfolio basis, at the user's election. If the user of the system is not an asset manager, the user can nonetheless track its activities with the system. For example, a service provider contractor could track the number of repair jobs it has open and completed for the various assets managed by the system 10. Importantly, the system 10 compares the actual progress of a listed asset with expected progress (based upon one or more traditional paths) of that asset as it moves from any point to the next on the continuum from acquisition to disposition. As an asset completes one such step, the system prompts the user with information about (including automated generation of materials, such as documents required and the like) the next step, positioning the user in the best possible place to move the asset along. Therefore, a “substep” of Step 430 is for the user to receive information and materials generated by the system 10, and act in response to same. In Step 440, the user can access and print management and/or cost-tracking work lists and reports on listed assets. Such available work lists include rent due lists, inspection lists, pre-closing documents needed, and the like. Available reports include profit/loss statements on an asset or assets, appraisal status reports, utility comparison reports, and the like.

Utilizing the method of the present invention, the management of the various aspects of real estate asset management is facilitated and vastly improved through the sharing of common information on asset, use of standard forms for various activities and transactions for such assets, electronic communication between and coordination of the various participants, and collection and analysis of information of each activity or transaction associated with same.

A number of embodiments of the invention have been described. Nevertheless, it will be understood that various modifications may be made without departing from the spirit and scope of the invention. For example, a variation of the system and method of the present invention could be used to manage other non-real estate assets. Accordingly, other embodiments are within the scope of the following claims.

1-23. (canceled)

24. A computer-implemented method for securing real estate management data, comprising the steps of:
listing one or more assets on a real estate management system, the listing comprising status data;
presenting, by a computer, the status data to a first user relating to a progression of the one or more assets through a plurality of asset management activities, the data presented via a first interface, the first interface customized, by the computer, to allow the first user access to data pertaining to each activity in the plurality of management activities;
presenting, by the computer, activity status data to a second user relating to the progression of at least one activity of the plurality of asset management activities to be provided by the second user, the activity data presented via a second interface, wherein the second interface is an entry point into a real estate management system associated with a role of the second user in a real estate transaction associated with an asset of the one or more assets and is customized, by the computer, to:
communicate data to the second user, the data pertaining to the at least one activity according to the role of the second user in the real estate transaction associated with an asset of the one or more assets; and to
restrict the second user from receiving data related to other roles associated with the real estate transaction associated with the asset;
receiving, at the computer, activity status updates from the second user via the second interface, the status updates relating to the at least one activity to be provided by the second user; and
presenting updated global status data to the first user via the first customized interface, the updated global status data based at least in part on the received status updates.

25. The method of claim 24, wherein first and second interfaces are web-based pages.

26. The method of claim 24, wherein the one or more assets is a real estate asset.

27. The method of claim 24, further comprising communicating global status data to third party participants in real estate management.

28. The method of claim 24, wherein the at least one user is selected from the group consisting of: brokers, lenders, asset managers and service providers.

29. The method of claim 28, wherein the service providers are selected from the group consisting of: contractors, subcontractors, attorneys, appraisers, title companies, real estate agents and inspectors.

30. The method of claim 24, further comprising creating an electronic record associated with each of the one or more assets listed by the first user, the electronic record comprising one of a sales record, a closing record, and a critical path record.

31. A system for securing real estate management data, comprising:
a first computer operable to present status data to a first user relating to a progression of one or more assets through a plurality of asset management activities, the data presented via a first interface, the first interface customized to allow the first user access to data pertaining to each activity in the plurality of management activities;
a second, separate, computer operable to present activity status data to a second user relating to the progression of at least one activity of the plurality of asset management activities to be provided by the second user, the activity data presented via a second interface, wherein the second interface is an entry point into a real estate management system associated with a role of the second user in a real estate transaction associated with an asset of the one or more assets and is customized to:
allow the second user access to data pertaining to the at least one activity according to the role of the second user in the real estate transaction associated with an asset of the one or more assets; and to
limit access of the second user to data related to other roles associated with the real estate transaction associated with the asset;
the second computer further operable to receive activity status updates from the second user via the second interface, the status updates relating to the at least one activity to be provided by the second user; and
the first computer further operable to present updated global status data to the first user via the first customized interface, the updated global status data based at least in part on the received status updates.

32. The system of claim 31, wherein the customized interfaces are customized by the first user.

33. The system of claim 31, wherein the customized interfaces are customized by an administrator of the system.

34. The system of claim 31, wherein the customized interfaces are customized by both an administrator of the system and by the user.

35. The system of claim 31, wherein at least one of the first computer and the second computer is operable to create one or more reports relating to the one or more assets.

36. The system of claim 35, wherein creating the one or more reports includes optional use of a filter to select parameters displayed on a report.

37. The system of claim 31, wherein the first computer and the second computer are operable to conduct a transaction between at least two of the users.

38. The system of claim 31, wherein at least one of the first computer and the second computer is operable to collect a fee from one or more users of the system.

39. The system of claim 31, wherein at least one of the first computer and the second computer is operable to compare the progression of the one or more assets through the plurality of asset management activities to at least one predetermined path for the progression.

40. The system of claim 39, wherein at least one of the first computer and the second computer is operable to prompt a primary user based upon the comparison of the actual progression to the at least one predetermined path for the progression.

41. The system of claim 39, wherein at least one of the first computer and the second computer is operable to automatically generate materials based upon the comparison of the actual progression to the at least one predetermined path for the progression.

42. A system for securing real estate management data comprising:
a task status module capable of maintaining status data relating to a progression of one or more assets through a path of asset management activities, each asset management activity to be performed by at least one of a plurality of real estate management participants;
a communication module capable of communicating messages between the user and at least one of the plurality of real estate management participants;
a reporting module capable of organizing status data into a presentation displayable to the user summarizing one or more asset management activities directed to one or more assets; and
a plurality of customized system interfaces that are customized entry points into a real estate management system with each entry point associated with a corresponding role of each management participant in a real estate transaction associated with an asset of the one or more assets, wherein each management participant accesses the system through one of the system interfaces to access information associated with the role of the management participant in a real estate transaction associated with an asset of the one or more assets and each interface limits access of the management participants the system according to the role of the management participant in the real estate transaction associated with the asset and according to the asset management activities to be performed by the management participants.

43. The system of claim 42, further comprising selecting one or more assets managed by the system.

44. The system of claim 42, wherein at least one activity of the plurality of asset management activities is provided by a user other than the at least one other user.

45. The system of claim 42, wherein at least one of the real estate management participants is a primary real estate management participant and the interface customized for the primary real estate management participant allows access to data pertaining to each asset management activity to be performed by the management participants.

46. The system of claim 42 further comprising:
receiving an activity assignment from a primary user via the first interface, the assignment intended for the at least one other user; and
presenting the assignment to the at least one other user via the second interface.
